(19) United States
(12) Patent Application Publication
(10) Pub. No.: US 2025/0174394 A1
(43) Pub. Date: May 29, 2025

(54) COIL ARRAY

(71) Applicant: TDK Corporation, Tokyo (JP)

(72) Inventors: Hitoshi OHKUBO, Tokyo (JP); Hokuto EDA, Tokyo (JP); Masazumi ARATA, Tokyo (JP); Kohei TAKAHASHI, Tokyo (JP); Hiroki ASAFUSA, Tokyo (JP); Takahiro NEMOTO, Tokyo (JP)

(73) Assignee: TDK Corporation, Tokyo (JP)

(21) Appl. No.: 18/888,799

(22) Filed: Sep. 18, 2024

(30) Foreign Application Priority Data
Nov. 27, 2023 (JP) 2023-199824
Nov. 27, 2023 (JP) 2023-199826

(51) Int. Cl. H01F 27/30; H01F 5/04; H01F 17/04

(52) U.S. Cl. CPC H01F 27/306; H01F 5/04; H01F 17/04

(57) ABSTRACT

In a coil array, two coil components are connected in parallel, whereby about twice the current can flow and the DC resistance can be reduced to about half as compared with the case where the coil component is used alone. That is, the coil characteristics is improved. Further, since the two coil components are arranged along a first direction parallel to a mounting substrate with the coil axes of the coils being common, the height is reduced.

### CROSS-REFERENCE TO RELATED APPLICATIONS

This application is based upon and claims the benefit of priority from Japanese Patent Applications No. 2023-199824 and No. 2023-199826, filed on 27 Nov. 2023, the entire content of which is incorporated herein by reference.

### TECHNICAL FIELD

The present disclosure relates to coil arrays.

### BACKGROUND

Japanese Unexamined Patent Application Publication No. 2019-106523 discloses a coil component in which a coil is provided in an element body having a mounting surface facing to a mounting substrate, and the coil has a coil axis extending in a direction orthogonal to the mounting surface.

### SUMMARY

It is difficult to use the above coil component in a circuit in which a relatively large current flows and to reduce the DC resistance.

The inventors have studied and newly found a technology capable of improving coil characteristics such as a large current and a low resistance and also reducing the height.

According to one aspect of the present disclosure, a coil array improving coil characteristics and reducing the height is provided.

A coil array according to one aspect of the present disclosure includes a plurality of coil components including an element body having a mounting surface facing a mounting substrate, a coil provided in the element body and having a coil axis along a first direction extending in parallel to the mounting surface, and a pair of external terminals provided on a surface of the element body and electrically connected to the coil. The plurality of the coil components is arranged along the first direction with the coil axis being common, and is connected in parallel.

In the coil array, the plurality of coil components is connected in parallel, so that coil characteristics such as large current and low resistance are improved. In this case, since the plurality of the coil components is arranged along the first direction extending in parallel to the mounting surface of the element body, it is possible to suppress an increase in height (that is, height reduction), compared to a form in which the plurality of the coil components is stacked on the mounting substrate.

### BRIEF DESCRIPTION OF THE DRAWINGS

FIG. 1 is a substantially perspective view showing a coil array according to a first embodiment.

FIG. 2 is a perspective view of the coil array shown in FIG. 1.

FIG. 3 shows an internal structure of the coil component shown in FIGS. 1 and 2.

FIG. 4 is a sectional view taken along line IV-IV of the coil component shown in FIG. 3.

FIG. 5 is a sectional view taken along line V-V of the coil component shown in FIG. 3.

FIG. 6 is a side view of the coil component shown in FIGS. 1 and 2.

FIG. 7 is an end view of the coil array shown in FIG. 1.

FIG. 8 is a substantially perspective view showing a coil array of a different aspect.

FIG. 9 is a substantially perspective view showing a coil array according to a second embodiment.

FIG. 10 is a perspective view of the coil array shown in FIG. 9.

FIG. 11 shows an internal structure of the coil component of FIGS. 9 and 10.

FIG. 12 is a sectional view taken along the line XII-XII of the coil component shown in FIG. 11.

FIG. 13 is a sectional view taken along line XIII-XIII of the coil component shown in FIG. 11.

FIG. 14 shows a position relationship of the coil of both coil components.

FIG. 15 is a table showing test results.

FIG. 16 is a graph showing test results.

FIG. 17 is a substantially perspective view showing a coil array of a different aspect.

FIG. 18 is a substantially perspective view showing a coil array of a different aspect.

### DETAILED DESCRIPTION

Hereinafter, embodiments of the present disclosure will be described in detail with reference to the accompanying drawings. In the description, the same reference numerals are used for the same elements or elements having the same functions, and redundant description will be omitted.

### First Embodiment

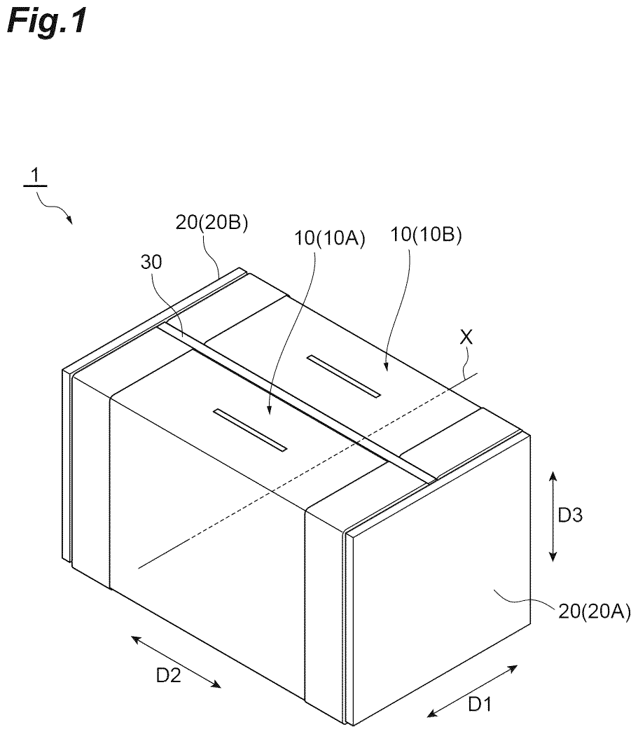

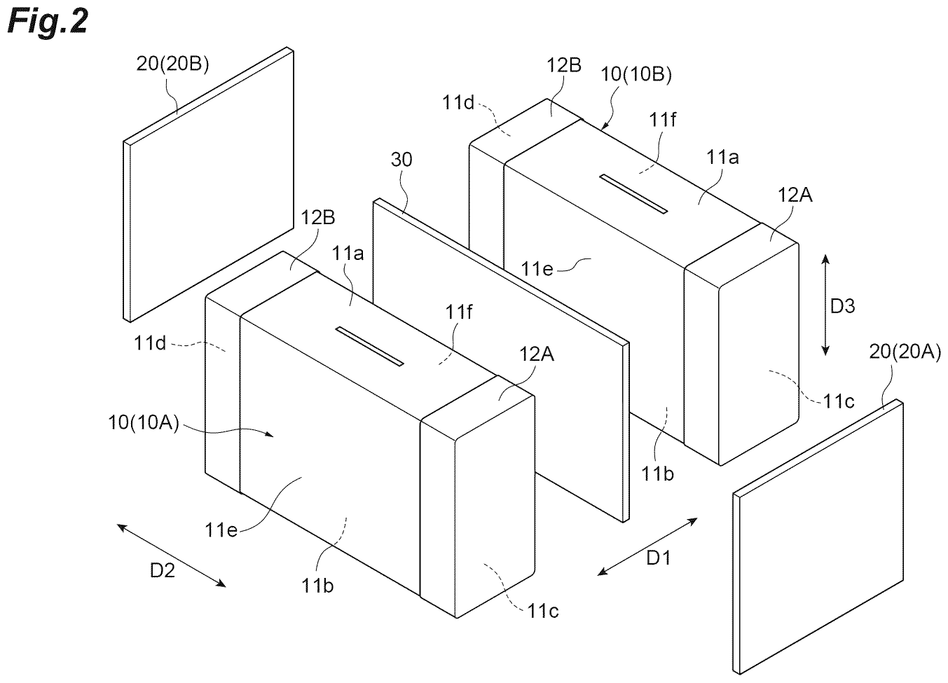

A coil array 1 according to the first embodiment has the configuration shown in FIGS. 1 and 2. The coil array 1 is implemented (e.g. solder mounted) on a mounting substrate 100 to be described later. The coil array 1 is applied to, for example, an in-vehicle device in which a large current is required. The coil array 1 is configured with a plurality of coil component 10, and is configured with two coil components 10 in the present embodiment. Hereinafter, the two coil components 10 are described to be a first coil component 10A and a second coil component 10B.

Each of the coil components 10 has an outer shape of a substantially cuboid and has a substantially rectangular shape when viewed from the height direction. Each of the coil components 10 may be designed with dimension of, for example, height 2.0 mm, a long side 2.5 mm, a short side 1.0 mm. Hereinafter, convenience of description, short side direction of the coil component 10 is also referred to as a first direction D1, long side direction is also referred to as a second direction D2, and height direction is also referred to as a third direction D3. The first direction D1, the second direction D2 and the third direction D3 are orthogonal to each other.

Each of the coil components 10 is configured to include an element body 11, a pair of external terminals 12A and 12B provided on a surface of the element body 11, and a coil 13 provided in the element body 11.

The element body 11 is configured by a magnetic material. In the present embodiment, the element body 11 is configured by a metal magnetic powder-containing resin which is a kind of magnetic material. The metal magnetic powder-containing resin is a bound powder in which a metal magnetic powder is bound by binder resin. The metal magnetic powder may be composed of, for example, an iron-nickel alloy (permalloy), carbonyl iron, amorphous or crystalline FeSiCr-based alloy, sendust. The binder resin is, for example, a thermosetting epoxy resin. In the present embodiment, the content of the metal magnetic powder in the bound powder is 80 to 92 vol. %, and 95 to 99 wt. %. From the viewpoint of the magnetic properties, the content of the metal magnetic powder in the bound powder may be 85 to 92 vol. % and 97 to 99 wt. %.

The element body 11 has a substantially cuboid outer shape and has six surfaces 11a to 11f. Among the surface 11a to 11f in the element body 11, an upper surface 11a and a lower surface 11b face each other in the third direction D3, an end surface 11c and an end surface 11d face each other in the second direction D2, and a side surface 11e and a side surface 11f face each other in the first direction D1. The upper surface 11a and the lower surface 11b are parallel to each other, the end surface 11c and the end surface 11d are parallel to each other, and the side surface 11e and the side surface 11f are parallel to each other. The lower surface 11b in the element body 11 is a surface in facing the mounting substrate 100 where the coil array 1 is mounted.

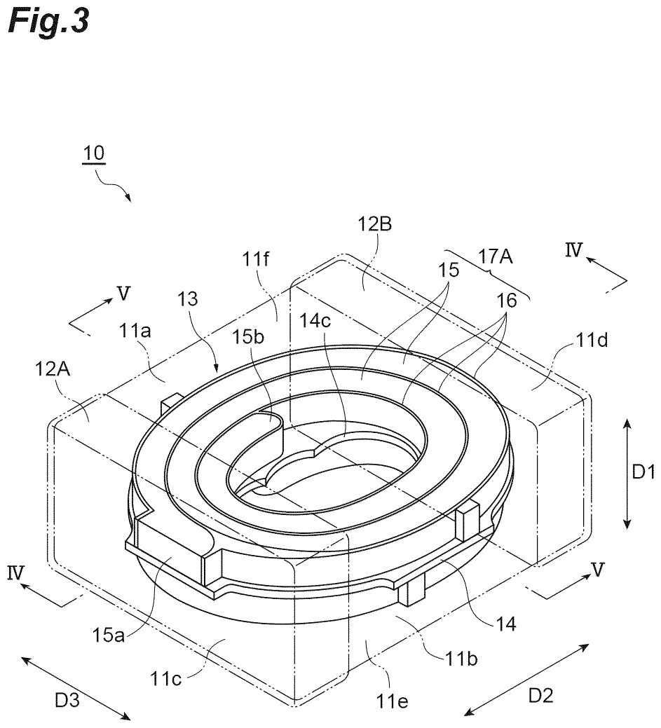

The coil 13 shown in FIGS. 3 to 5 is provided in the element body 11. The coil 13 according to the present embodiment is configured to include an insulating substrate 14, a first coil portion 17A, and a second coil portion 17B.

The insulating substrate 14 is a plate-like member configured with a nonmagnetic insulating material and extends orthogonally to the first direction D1. The insulating substrate 14 has a substantially elliptical annular shape when viewed from the first direction D1. The center portion of the insulating substrate 14 is provided with an elliptical through hole 14c. A substrate obtained by impregnating a glass cloth with an epoxy-based resin can be used as the insulating substrate 14, which has a thickness of 10 to 60 μm. Other than the epoxy-based resin, a BT resin, polyimide, aramid, or the like may be used. Ceramic or glass may be used as the material of the insulating substrate 14. A mass-produced printed substrate material may be used as the material of the insulating substrate 14, or a resin material used for a BT-printed substrate, a FR4 printed substrate, or a FR5 printed substrate may be used.

The first coil portion 17A is configured to include a planar coil pattern 15 provided on the one of the surfaces (surface on the side surface 11f side) 14a of the insulating substrate 14 and a resin wall 16 provided in the interline, inner periphery, and outer periphery of the planar coil pattern 15. The planar coil pattern 15 is formed by plating with a conductor material such as Cu. The planar coil pattern 15 is formed to be wound around the through hole 14c of the insulating substrate 14. An outer peripheral end 15a of the planar coil pattern 15 reached the end surface 11c of the element body 11 and was exposed from the end surface 11c. An inner peripheral end 15b of the planar coil pattern 15 was terminated at the edge of the through hole 14c of the insulating substrate 14. The resin wall 16 is configured with an insulating resin material. The resin wall 16 can be provided on the insulating substrate 14 before forming the planar coil pattern 15. In this case, the planar coil pattern 15 is plated and grown in a gap defined by the resin wall 16. That is, the formation region of the planar coil pattern 15 is defined by the resin wall 16 provided on the insulating substrate 14. The resin wall 16 can be provided on the insulating substrate 14 after forming the planar coil pattern 15. In this case, the resin wall 16 is provided on the planar coil pattern 15 by filling, application, or the like.

The second coil portion 17B is configured to include a planar coil pattern 15 provided on the other surface 14b (surface on the side surface 11e side) of the insulating substrate 14 and a resin wall 16 provided in the interline, inner periphery, and outer periphery of the planar coil pattern 15. Similarly to the planar coil pattern 15 of the first coil portion 17A, the planar coil pattern 15 of the second coil portion 17B is formed by plating with a conductor material such as Cu. Similarly to the planar coil pattern 15 of the first coil portion 17A, the planar coil pattern 15 of the second coil portion 17B is formed to be wound around the through hole 14c of the insulating substrate 14. An outer peripheral end 15a of the planar coil pattern 15 of the second coil portion 17B reaches the end surface 11d of the element body 11 and is exposed from the end surface 11d. An inner peripheral end 15b of the planar coil pattern 15 of the second coil portion 17B is terminated at the edge of the through hole 14c of the insulating substrate 14 (more specifically, at the position to superpose the inner peripheral end 15b of the planar coil pattern 15 of the first coil portion 17A in the first direction D1). Similarly to the first coil portion 17A, the resin wall 16 of the second coil portion 17B is configured with a resin material of insulating the resin wall 16.

In the first coil portion 17A and the second coil portion 17B, the resin wall 16 located in the inner and/or outer periphery of the planar coil pattern 15 can be designed to be thicker than the resin wall 16 located in the interline of the planar coil pattern 15.

In the first coil portion 17A and the second coil portion 17B, the surface of the planar coil pattern 15 exposed from the resin wall 16 is covered by an insulating layer 18. The insulating layer 18 is provided across the entire surface of the upper surface of the planar coil pattern 15 between the resin wall 16 adjacent to each other. The insulating layer 18 is configured by a resin such as an epoxy resin, a polyimide resin, or the like. In the present embodiment, the insulating layer 18 is an electrodeposited layer formed using an electrodeposition method, and has a uniform thickness.

The inner peripheral end 15b of the planar coil pattern 15 of the first coil portion 17A and the inner peripheral end 15b of the planar coil pattern 15 of the second coil portion 17B are connected via a through-hole conductor 19 penetrating the insulating substrate 14 at the edge of the through hole 14c. The through-hole conductor 19 may be configured by a hole provided in the insulating substrate 14 and a conductive material (for example, a metal such as Cu) filled in the hole.

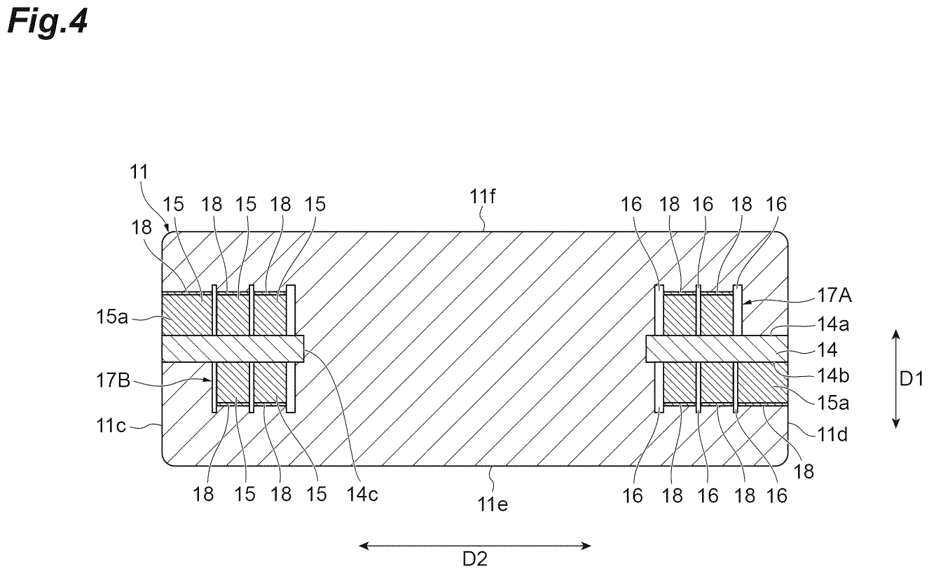

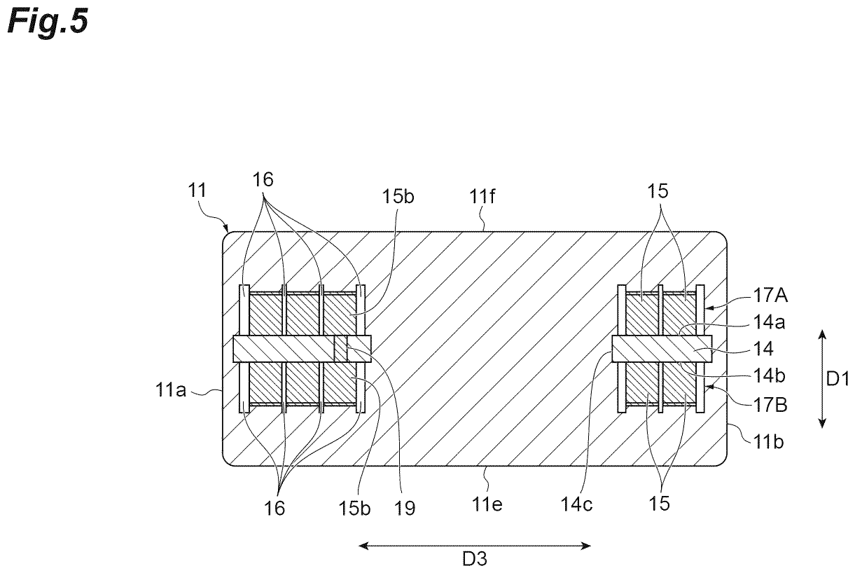

As shown in FIGS. 4 and 5, the magnetic material constituting the element body 11 integrally covers the coil 13. Specifically, the magnetic material constituting the element body 11 covers the coil 13 from the vertical direction and also covers the outer periphery of the coil 13. Further, the magnetic material constituting the element body 11 fills the inner region of the coil 13.

The external terminal 12A is provided on the end surface 11c side of the element body 11, and the external terminal 12B is provided on the end surface 11d side of the element body 11. The external terminal 12A integrally covers the end surface 11c, the upper surface 11a near the end surface 11c, the lower surface 11b near the end surface 11c, the side surface 11e near the end surface 11c, and the side surface 11f near the end surface 11c, and is connected to the outer peripheral end 15a of the planar coil pattern 15 of the first coil portion 17A exposed from the end surface 11c. The external terminal 12A integrally covers the end surface 11d, and the upper surface 11a near the end surface 11d, the lower surface 11b near the end surface 11d, the side surface 11e near the end surface 11d, and the side surface 11f near the end surface 11d, and is connected to the outer peripheral end 15a of the planar coil pattern 15 of the second coil portion 17B exposed from the end surface 11d.

In the coil array 1, as shown in FIG. 1, the two coil components 10 are arranged along the first direction D1 in a posture in which the side surfaces 11e and 11f of the element body 11 face each other. Specifically, the side surface 11f of the element body 11 of the first coil component 10A and the side surface 11e of the element body 11 of the second coil component 10B are facing each other in the first direction D1. Thus, the coils 13 located in the element bodies 11 of the coil components 10 have a common coil axis X extending in the first direction D1.

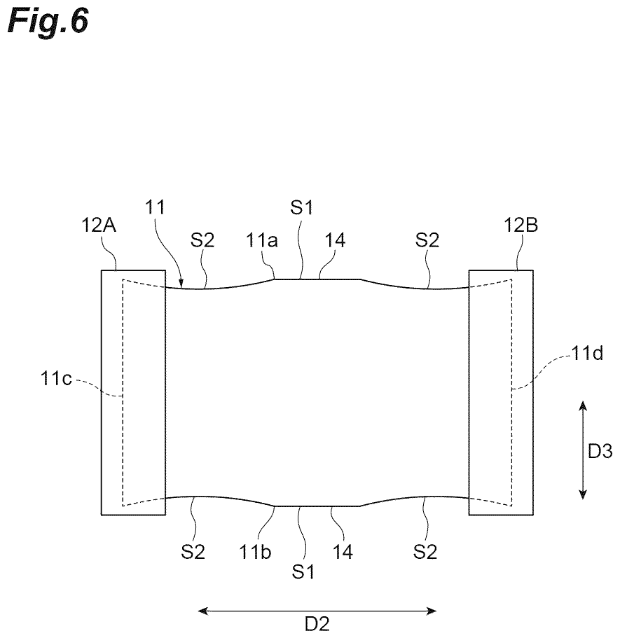

In the present embodiment, as shown in FIG. 6, in each of the coil components 10, the upper surface 11a and the lower surface 11b have convex portions S1 and concave portions S2 when viewed in the first direction D1. The convex portions S1 of the upper surface 11a and the lower surface 11b are positioned substantially at the center of the element body 11 with respect to the second direction D2, and the concave portions S2 are positioned at both sides of the convex portion S1. The convex portion S1 is substantially flat and the concave portion S2 is slightly concaved and slightly curved relative to the convex portion S1. Each of the convex portions S1 corresponds to a portion of the insulating substrate 14 exposed from the element body 11, and the portion of the insulating substrate 14 is exposed in the convex portions S1 from the upper surface 11a and the lower surface 11b of the element body 11.

The side surfaces 11e and 11f of the element body 11 of each of the coil components 10 may be a flat surface, or at least one of the side surfaces 11e and 11f a is bent (expanded) convexly toward the outer side.

In the coil array 1 according to the present embodiment, a magnetic sheet 30 is interposed between the two coil components 10. The magnetic sheet 30 has substantially the same dimensions as the side surface 11f of the element body 11 of the first coil component 10A, and the magnetic sheet 30 covers the entire surface of the side surface 11f of the element body 11 of the first coil component 10A and the entire surface of the side surface 11e of the element body 11 of the second coil component 10B. The magnetic sheet 30 is configured to include a magnetic material such as iron-nickel alloy (permalloy), carbonyl iron, amorphous or crystalline FeSiCr alloy, sendust, and the like, and a binder resin such as a thermosetting epoxy resin.

In the coil array 1, the two coil components 10 are connected in parallel. In the present embodiment, the two coil components 10 are connected in parallel by a pair of metal plates 20. Hereinafter, the pair of the metal plates 20 is said to be a first metal plate 20A and a second metal plate 20B. Each of the metal plates 20 may be configured by pure copper (more specifically, tough pitch copper) as an example, and Ni/Sn plating may be applied to the surface.

The first metal plate 20A is located on the end surface 11c side of the element body 11 of each of the coil components 10 and covers the external terminals 12A covering the end surfaces 11c. The first metal plate 20A has a size of about 2 of the end surface 11c, and integrally covers the external terminal 12A of the first coil component 10A and the external terminal 12A of the second coil component 10B and is electrically connected to the external terminal 12A of the first coil component 10A and the external terminal 12A of the second coil component 10B. Similarly, the second metal plate 20B is located on the end surface 11d side of the element body 11 of each of the coil components 10 and covers the external terminals 12B covering the end surfaces 11d. The second metal plate 20B has a size of about 2 of the end surface 11d, and integrally covers the external terminal 12B of the first coil component 10A and the external terminal 12B of the second coil component 10B and is electrically connected to the external terminal 12B of the first coil component 10A and the external terminal 12B of the second coil component 10B. Each of the metal plates 20 may be attached to the external terminals 12A and 12B using a conductive adhesive.

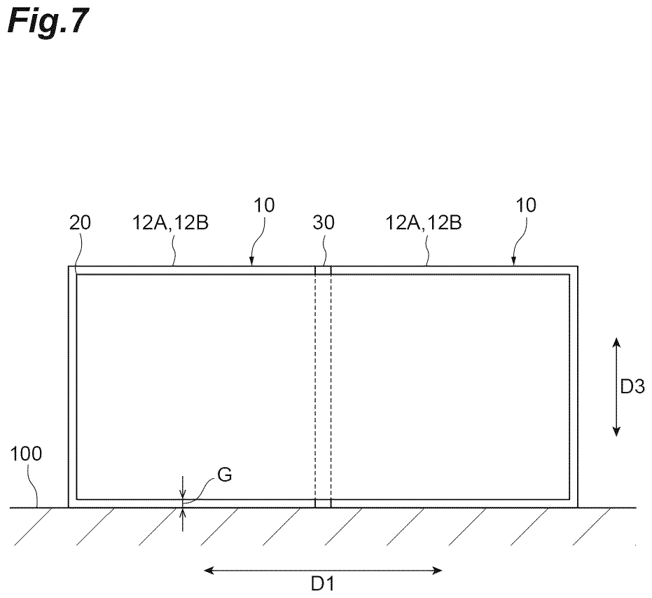

In the present embodiment, each of the metal plates 20 is designed to retract a predetermined distance from the outer edge of the external terminals 12A and 12B as shown in FIG. 7. That is, when viewed in the second direction D2, each of the metal plates 20 does not protrude outward beyond the outer edge of the external terminals 12A and 12B. In particular, on the lower side of the coil component 10 (i.e., the lower surface 11b side of the element body 11), the lower edge of each of the metal plates 20 is regressed by a distance G from the lower edges of the external terminals 12A and 12B. Thereby, each of the metal plates 20 is apart from the mounting substrate 100 in which the coil array 1 is to be mounted.

As described above, in the coil array 1 according to the first embodiment, the two coil components 10 are connected in parallel, thereby about twice the current flows, and the DC resistance can be reduced to about half in comparison with the case where the coil component is used alone. That is, the coil characteristics is improved. More over the two coil components 10 are arranged along the first direction D1 parallel to the mounting substrate 100 while making the coil axis X of the coils 13 common, so that the height is reduced. That is, in the form in which the plurality of the coil components 10 is stacked on the mounting substrate 100, the height increases as the number of the coil components 10 increases, but in the form in which the plurality of the coil component 10 is arranged along the first direction D1 as in the coil array 1 of the present embodiment, it is suppressed that the height (dimension with respect to the third direction D3) does not change even when the number of the coil components 10 increases. Further, in the coil array 1, the foot print is reduced by arranging each of the coil components 10 in a vertical posture (not a horizontal posture) with respect to the mounting substrate 100.

In the coil array 1, since the two coil components 10 are lined up with the same posture, the directions of the magnetic flux generated in the coils 13 is the same when the voltage is applied between the pair of the metal plates 20. The magnetic flux of the two coil components 10 are coupled.

In addition, in the coil array 1, the lower surface 11b of the element body 11 of each of the coil components 10 has the convex portions S1 and the concave portions S2. Therefore, the elongation of the creeping distance between the pair of the external terminals 12A and 12B as compared with the case where the lower surface 11b is flat is achieved. Accordingly, a situation in which an electrical short occurs between the pair of the external terminals 12A and 12B is effectively suppressed.

Further, in the coil array 1, the magnetic sheet 30 is interposed between the two coil components 10, whereby the strength is increased as compared to the case where there is a gap between the two coil components 10. In particular, high strength against vibration is realized.

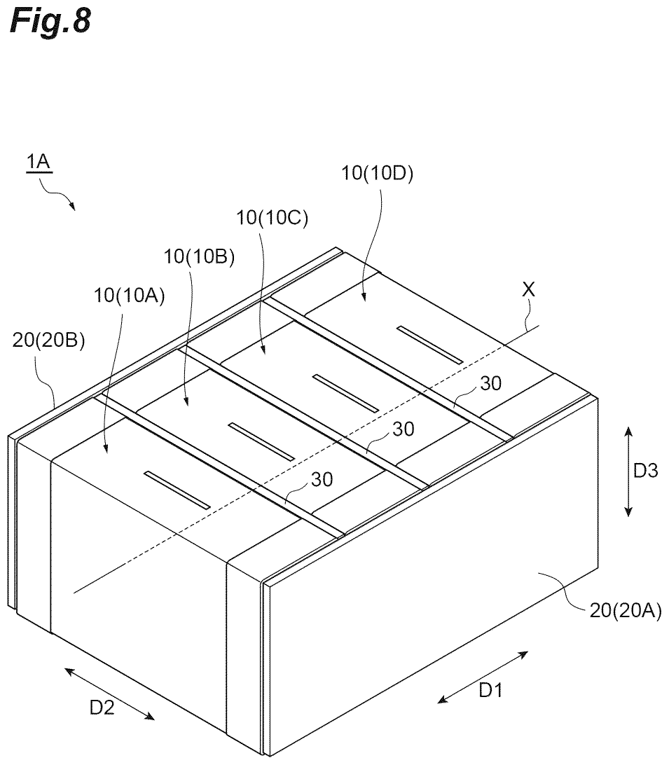

The number of the coil components 10 in the coil array 1 is not limited to two, and can be increased appropriately. FIG. 8 shows a coil array 1A with four coil components 10A to 10D. Depending on the number of the coil components 10, the dimensions of the metal plate 20 can be appropriately elongated. The magnetic sheets 30 can be interposed between the adjacent coil components 10 in the first direction D1. In the coil array 1A, about four times the current can flow and the DC resistance can be reduced to about ¼ as compared with the case where the coil component 10 is used alone.

In the coil array 1A, similar to the coil array 1, all of the four coil components 10A to 10D can be arranged with the same posture. The direction of the magnetic flux generated in the coils 13 is the same when the voltage is applied between the pair of the metal plates 20. In the coil array 1A, the directions of a part the coil components 10 (for example, only the coil component 10B) may be inverted so that the directions of the magnetic fluxes generated in the coils 13 are opposite to those of the other coil components. Interference of coil magnetic flux may occur between the coil component 10A and the coil component 10B adjacent to each other.

In the first embodiment, the coil may be in a form including an insulating substrate or in a form not including an insulating substrate. In addition, the coil is not limited to an elliptical annular, and may be an annular, a rectangular annular, or the like. Further, the number of turns of the coil may be increased or decreased as appropriate.

### Second Embodiment

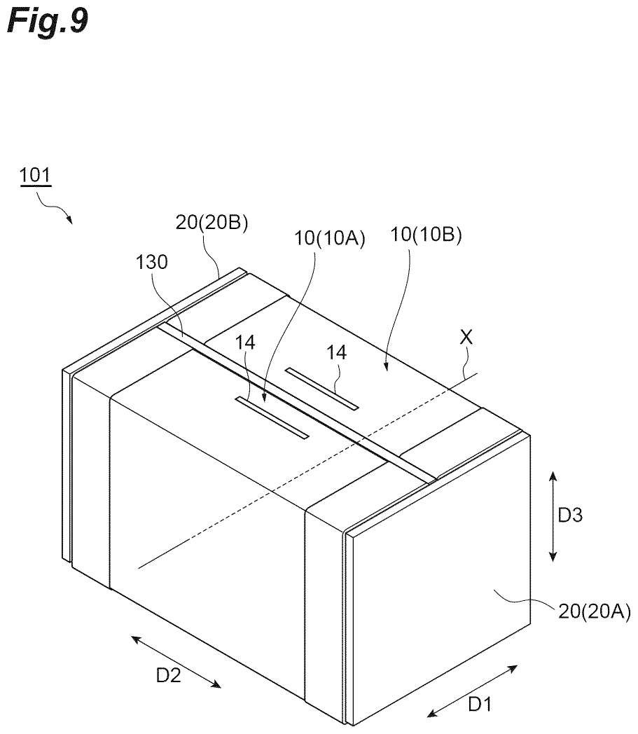

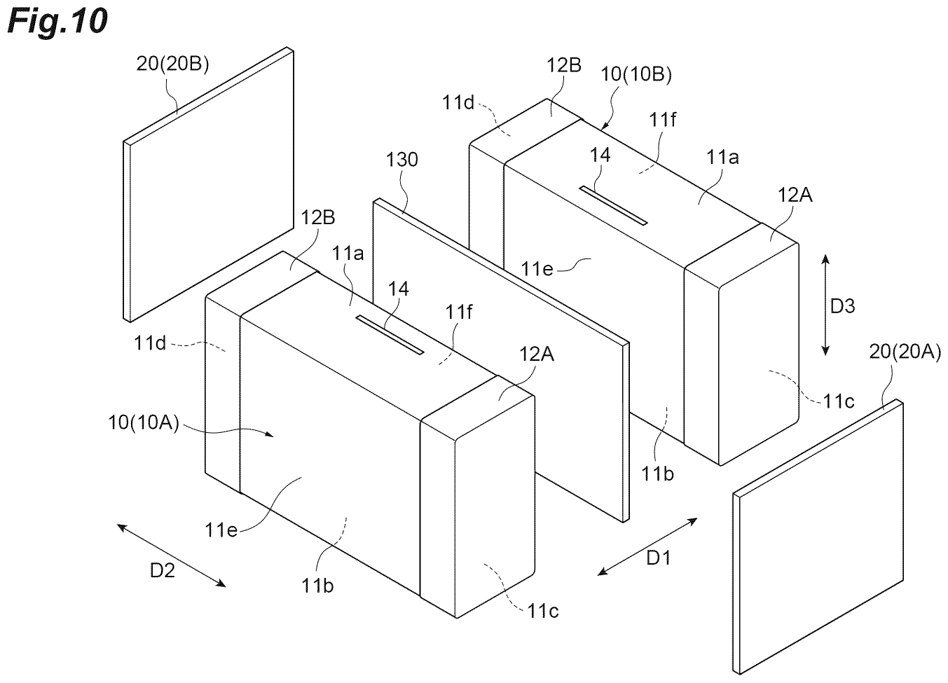

A coil array 101 according to the second embodiment has the configuration shown in FIGS. 9 and 10. The coil array 101 is implemented (e.g. solder mounted) on a mounting substrate 100 to be described later. The coil array 101 is applied to, for example, an in-vehicle device in which a large current is required. The coil array 101 is configured with a plurality of coil component 10, and is configured with two coil components 10 in the present embodiment. Hereinafter, the two coil components 10 are described to be a first coil component 10A and a second coil component 10B.

Each of the coil components 10 has an outer shape of a substantially cuboid and has a substantially rectangular shape when viewed from the height direction. Each of the coil components 10 may be designed with dimension of, for example, height 2.0 mm, a long side 2.5 mm, a short side 1.0 mm. Hereinafter, convenience of description, short side direction of the coil component 10 is also referred to as a first direction D1, long side direction is also referred to as a second direction D2, and height direction is also referred to as a third direction D3. The first direction D1, the second direction D2 and the third direction D3 are orthogonal to each other.

Each of the coil components 10 is configured to include an element body 11, a pair of external terminals 12A and 12B provided on a surface of the element body 11, and a coil 13 provided in the element body 11.

The element body 11 is configured by a magnetic material. In the present embodiment, the element body 11 is configured by a metal magnetic powder-containing resin which is a kind of magnetic material. The metal magnetic powder-containing resin is a bound powder in which a metal magnetic powder is bound by binder resin. The metal magnetic powder may be composed of, for example, an iron-nickel alloy (permalloy), carbonyl iron, amorphous or crystalline FeSiCr-based alloy, sendust. The binder resin is, for example, a thermosetting epoxy resin. In the present embodiment, the content of the metal magnetic powder in the bound powder is 80 to 92 vol. %, and 95 to 99 wt. %. From the viewpoint of the magnetic properties, the content of the metal magnetic powder in the bound powder may be 85 to 92 vol. % and 97 to 99 wt. %.

The element body 11 has a substantially cuboid outer shape and has six surfaces 11a to 11f. Among the surface 11a to 11f in the element body 11, an upper surface 11a and a lower surface 11b face each other in the third direction D3, an end surface 11c and an end surface 11d face each other in the second direction D2, and a side surface 11e and a side surface 11f face each other in the first direction D1. The upper surface 11a and the lower surface 11b are parallel to each other, the end surface 11c and the end surface 11d are parallel to each other, and the side surface 11e and the side surface 11f are parallel to each other. The lower surface 11b in the element body 11 is a surface in facing the mounting substrate 100 where the coil array 101 is mounted.

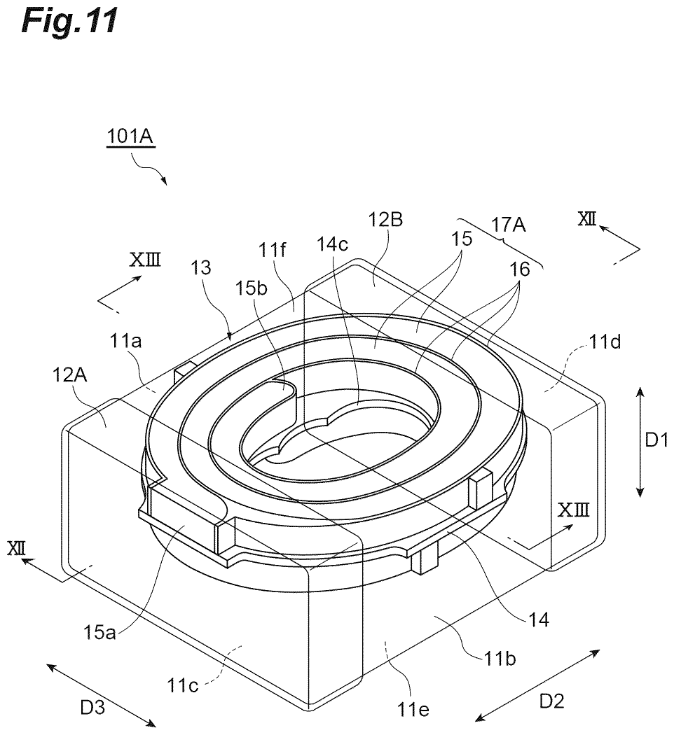

The coil 13 shown in FIGS. 11 to 13 is provided in the element body 11. The coil 13 according to the present embodiment is configured to include an insulating substrate 14, a first coil portion 17A, and a second coil portion 17B.

The insulating substrate 14 is a plate-like member configured with a nonmagnetic insulating material and extends orthogonally to the first direction D1. The insulating substrate 14 has a substantially elliptical annular shape when viewed from the first direction D1. The center portion of the insulating substrate 14 is provided with an elliptical through hole 14c. A substrate obtained by impregnating a glass cloth with an epoxy-based resin can be used as the insulating substrate 14, which has a thickness of 10 to 60 μm. Other than the epoxy-based resin, a BT resin, polyimide, aramid, or the like may be used. Ceramic or glass may be used as the material of the insulating substrate 14. A mass-produced printed substrate material may be used as the material of the insulating substrate 14, or a resin material used for a BT-printed substrate, a FR4 printed substrate, or a FR5 printed substrate may be used.

The first coil portion 17A is configured to include a planar coil pattern 15 provided on the one of the surfaces (surface on the side surface 11f side) 14a of the insulating substrate 14 and a resin wall 16 provided in the interline, inner periphery, and outer periphery of the planar coil pattern 15. The planar coil pattern 15 is formed by plating with a conductor material such as Cu. The planar coil pattern 15 is formed to be wound around the through hole 14c of the insulating substrate 14. An outer peripheral end 15a of the planar coil pattern 15 reached the end surface 11c of the element body 11 and was exposed from the end surface 11c. An inner peripheral end 15b of the planar coil pattern 15 was terminated at the edge of the through hole 14c of the insulating substrate 14. The resin wall 16 is configured with an insulating resin material. The resin wall 16 can be provided on the insulating substrate 14 before forming the planar coil pattern 15. In this case, the planar coil pattern 15 is plated and grown in a gap defined by the resin wall 16. That is, the formation region of the planar coil pattern 15 is defined by the resin wall 16 provided on the insulating substrate 14. The resin wall 16 can be provided on the insulating substrate 14 after forming the planar coil pattern 15. In this case, the resin wall 16 is provided on the planar coil pattern 15 by filling, application, or the like.

The second coil portion 17B is configured to include a planar coil pattern 15 provided on the other surface 14b (surface on the side surface 11e side) of the insulating substrate 14 and a resin wall 16 provided in the interline, inner periphery, and outer periphery of the planar coil pattern 15. Similarly to the planar coil pattern 15 of the first coil portion 17A, the planar coil pattern 15 of the second coil portion 17B is formed by plating with a conductor material such as Cu. Similarly to the planar coil pattern 15 of the first coil portion 17A, the planar coil pattern 15 of the second coil portion 17B is formed to be wound around the through hole 14c of the insulating substrate 14. An outer peripheral end 15a of the planar coil pattern 15 of the second coil portion 17B reaches the end surface 11d of the element body 11 and is exposed from the end surface 11d. An inner peripheral end 15b of the planar coil pattern 15 of the second coil portion 17B is terminated at the edge of the through hole 14c of the insulating substrate 14 (more specifically, at the position to superpose the inner peripheral end 15b of the planar coil pattern 15 of the first coil portion 17A in the first direction D1). Similarly to the first coil portion 17A, the resin wall 16 of the second coil portion 17B is configured with a resin material of insulating the resin wall 16.

In the first coil portion 17A and the second coil portion 17B, the resin wall 16 located in the inner and/or outer periphery of the planar coil pattern 15 can be designed to be thicker than the resin wall 16 located in the interline of the planar coil pattern 15.

In the first coil portion 17A and the second coil portion 17B, the surface of the planar coil pattern 15 exposed from the resin wall 16 is covered by an insulating layer 18. The insulating layer 18 is provided across the entire surface of the upper surface of the planar coil pattern 15 between the resin wall 16 adjacent to each other. The insulating layer 18 is configured by a resin such as an epoxy resin, a polyimide resin, or the like. In the present embodiment, the insulating layer 18 is an electrodeposited layer formed using an electrodeposition method, and has a uniform thickness.

The inner peripheral end 15b of the planar coil pattern 15 of the first coil portion 17A and the inner peripheral end 15b of the planar coil pattern 15 of the second coil portion 17B are connected via a through-hole conductor 19 penetrating the insulating substrate 14 at the edge of the through hole 14c. The through-hole conductor 19 may be configured by a hole provided in the insulating substrate 14 and a conductive material (for example, a metal such as Cu) filled in the hole.

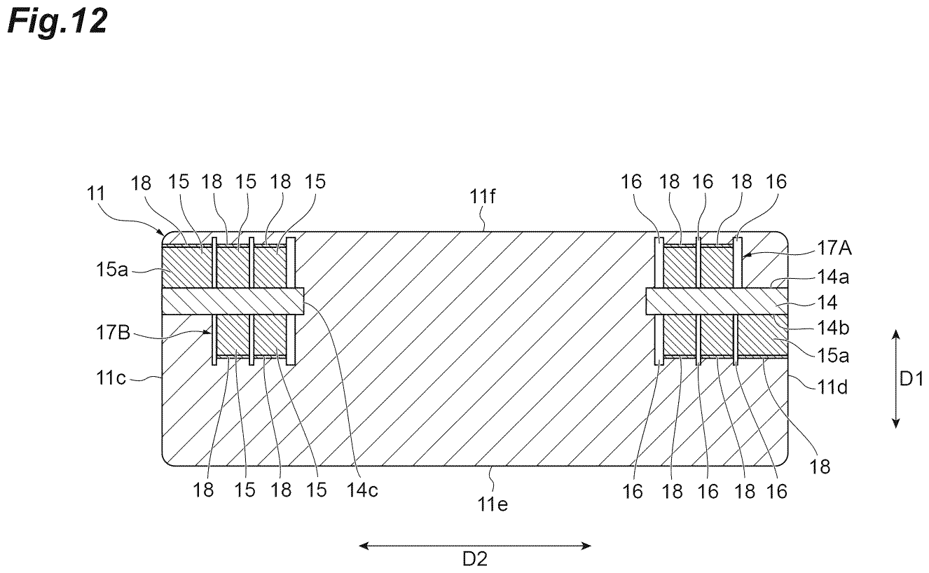

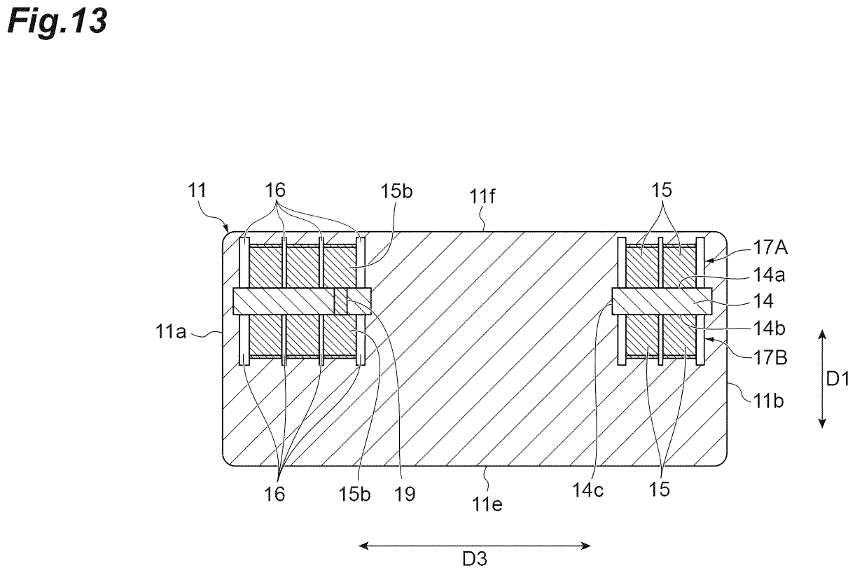

As shown in FIGS. 12 and 13, the magnetic material constituting the element body 11 integrally covers the coil 13. Specifically, the magnetic material constituting the element body 11 covers the coil 13 from the vertical direction and also covers the outer periphery of the coil 13. Further, the magnetic material constituting the element body 11 fills the inner region of the coil 13. The magnetic material constituting the element body 11 can be formed by molding over the coil 13. The dimension with respect to the first direction D1 (thickness) of the element body 11 can be easily and freely adjusted by polishing the magnetic material after molding.

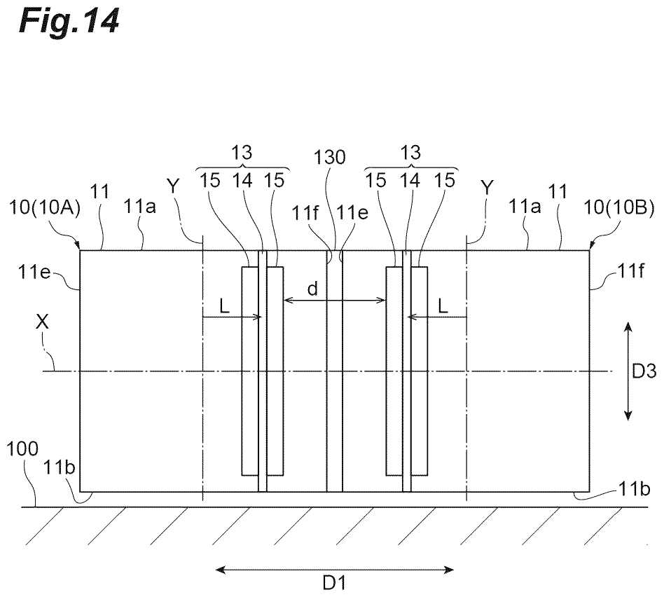

In the first coil component 10A shown in FIG. 11, the coil 13 is wholly biased toward an upper side (side surface 11f side). That is, the coil 13 in the first coil component 10A is offset to the side surface 11f side from an intermediate position Y of the element body 11 with respect to the first direction D1. The coil 13 in the second coil component 10B is wholly biased to a lower side (side surface 11e side). That is, the coil 13 of the second coil component 10B is offset to the side surface 11e side from the intermediate position Y of the element body 11 with respect to the first direction D1. As a result, as shown in FIG. 14, the coils 13 of the coil components 10 approach each other. At this time, the insulating substrate 14 of the coil 13 in the first coil component 10A is offset to the side surface 11f side from the intermediate position Y of the element body 11 in the first direction D1, and the insulating substrate 14 of the coil 13 in the second coil component 10B is offset to the side surface 11e side from the intermediate position Y of the element body 11 in the first direction D1. In the present embodiment, the offset length L of the insulating substrate 14 of the coil 13 in the first coil component 10A and the offset length L of the insulating substrate 14 of the coil 13 in the second coil component 10B are the same. The planar coil pattern 15 of the coil 13 in the first coil component 10A and the planar coil pattern 15 of the coil 13 in the second coil component 10B are spaced by a distance d with respect to the first direction D1.

The external terminal 12A is provided on the end surface 11c side of the element body 11, and the external terminal 12B is provided on the end surface 11d side of the element body 11. The external terminal 12A integrally covers the end surface 11c, the upper surface 11a near the end surface 11c, the lower surface 11b near the end surface 11c, the side surface 11e near the end surface 11c, and the side surface 11f near the end surface 11c, and is connected to the outer peripheral end 15a of the planar coil pattern 15 of the first coil portion 17A exposed from the end surface 11c. The external terminal 12A integrally covers the end surface 11d, and the upper surface 11a near the end surface 11d, the lower surface 11b near the end surface 11d, the side surface 11e near the end surface 11d, and the side surface 11f near the end surface 11d, and is connected to the outer peripheral end 15a of the planar coil pattern 15 of the second coil portion 17B exposed from the end surface 11d.

In the coil array 101, as shown in FIG. 9, the two coil components 10 are arranged along the first direction D1 in a posture in which the side surfaces 11e and 11f of the element body 11 face each other. Specifically, the side surface 11f of the element body 11 of the first coil component 10A and the side surface 11e of the element body 11 of the second coil component 10B are facing each other in the first direction D1. Thus, the coils 13 located in the element bodies 11 of the coil components 10 have a common coil axis X extending in the first direction D1.

In the coil array 101 according to the present embodiment, an adhesive layer 130 is interposed between the two coil components 10. The adhesive layer 130 has substantially the same dimensions as the side surface 11f of the element body 11 of the first coil component 10A, covering the entire surface of the side surface 11f of the element body 11 of the first coil component 10A and the entire surface of the side surface 11e of the element body 11 of the second coil component 10B. The adhesive layer 130 is configured with polyethylene as an example. The adhesive layer 130 may be configured with a non-magnetic material or may be configured with a magnetic material.

In the coil array 101, the two coil components 10 are connected in parallel. In the present embodiment, the two coil components 10 are connected in parallel by a pair of metal plates 20. Hereinafter, the pair of the metal plates 20 is said to be a first metal plate 20A and a second metal plate 20B. Each of the metal plates 20 may be configured by pure copper (more specifically, tough pitch copper) as an example, and Ni/Sn plating may be applied to the surface.

The first metal plate 20A is located on the end surface 11c side of the element body 11 of each of the coil components 10 and covers the external terminals 12A covering the end surfaces 11c. The first metal plate 20A has a size of about 2 of the end surface 11c, and integrally covers the external terminal 12A of the first coil component 10A and the external terminal 12A of the second coil component 10B and is electrically connected to the external terminal 12A of the first coil component 10A and the external terminal 12A of the second coil component 10B. Similarly, the second metal plate 20B is located on the end surface 11d side of the element body 11 of each of the coil components 10 and covers the external terminals 12B covering the end surfaces 11d. The second metal plate 20B has a size of about 2 of the end surface 11d, and integrally covers the external terminal 12B of the first coil component 10A and the external terminal 12B of the second coil component 10B and is electrically connected to the external terminal 12B of the first coil component 10A and the external terminal 12B of the second coil component 10B. Each of the metal plates 20 may be attached to the external terminals 12A and 12B using a conductive adhesive.

Here, Japanese Unexamined Patent Application Publication No. 2018-137421 discloses a coil component in which a first coil and a second coil overlap each other with a substrate interposed therebetween, and attempts to increase the coupling coefficient by arranging the substrate in a separation space between the first coil and the second coil. The inventors have studied the coupling coefficient of the coils and newly found a technology capable of adjusting the coupling coefficient.

The coil array 101 according to the second embodiment is biased so that both of the insulating substrates 14 of the coils 13 in the pair of the adjacent coil components 10 approach each other, whereby the distance of the planar coil pattern 15 formed on the main surfaces 14a and 14b of the insulating substrate 14 is reduced. The distance between the planar coil patterns 15 of the pair of the adjacent coil components 10 may be appropriately designed and changed by adjusting the thickness of the magnetic material constituting the element body 11, and accordingly, the coupling coefficient may be adjusted to a desired value.

The inventors implemented analysis by simulation using 3D models obtained by simulating the examples shown below in order to confirm the relationship between the bias and the coupling coefficient of the insulating substrate 14. For the present simulation analysis, simulation software of ANSYS Electronics Desktop Maxwell 2021R1 manufactured by ANSYS was used. In each of the simulation models 1 to 5, as dimensions with respect to the first direction D1, a coil array was used in which a pair of adjacent coil components having an element body with a thickness of 900 μm, a substrate with a thickness of 60 μm, a planar coil pattern with a height of 200 μm, and a resin wall with a height of 225 μm. As the magnetic material constituting the element body of each of the simulation models 1 to 5, the same material having the same magnetic permeability was used. In addition, the coil components were adhered using an adhesive layer configured with a resin material and having a thickness of 20 μm. In each of the simulation models 1 to 5, the offset length L of the substrates of both coil components was the same.

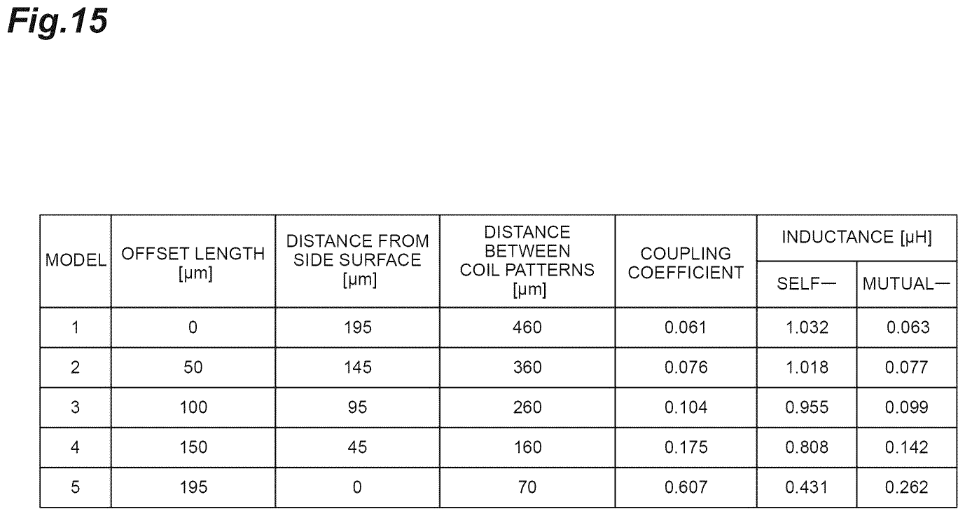

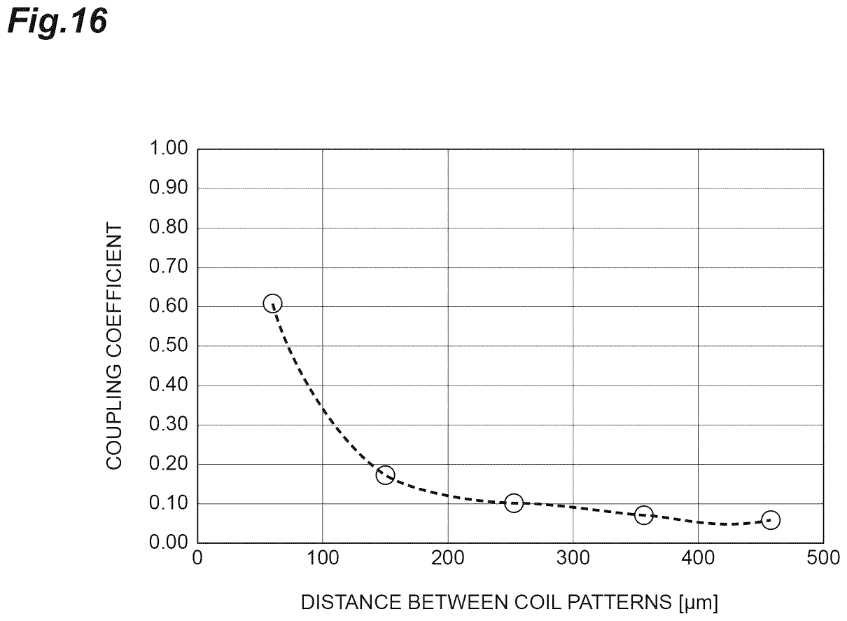

The results are shown in FIGS. 15 and 16. That is, the coupling coefficient in a simulation model 1 (not offset from the intermediate position Y of the element body with respect to the first direction D1) was 0.061, the coupling coefficient in a simulation model 2 (50 μm offset from the intermediate position Y of the element body to the side surface) was 0.076, the coupling coefficient in a simulation model 3 (100 μm offset from the intermediate position Y of the element body to the side surface) was 0.104, the coupling coefficient in a simulation model 4 (150 μm offset from the intermediate position Y of the element body to the side surface) was 0.175, and the coupling coefficient in a simulation model 5 (195 μm offset from the intermediate position Y of the element body to the side surface) was 0.607.

As described above, it was confirmed that the coupling coefficient was changed by changing the offset length L of the substrate and the distance d between the coil patterns. Therefore, the coupling coefficient can be appropriately adjusted by adjusting the offset length L of the substrate and the distance d between the coil patterns, for example, by adjusting the thickness of the magnetic material constituting the element body. In addition, it was confirmed that the coupling coefficient increases as the offset length L of the substrate increases. For example, as in the simulation models 4 and 5, the offset length L is not less than 150 μm, and a coil pattern distance d is not more than 160 μm, a relatively high coupling coefficient of 0.150 or more can be obtained.

The present invention is not limited to the above embodiments and may be variously modified. For example, in a pair of adjacent coil component, it is not necessarily limited to the configuration in which both of the substrates are biased, only one of the substrates may be biased. The offset lengths L of both of the substrates may be the same or different.

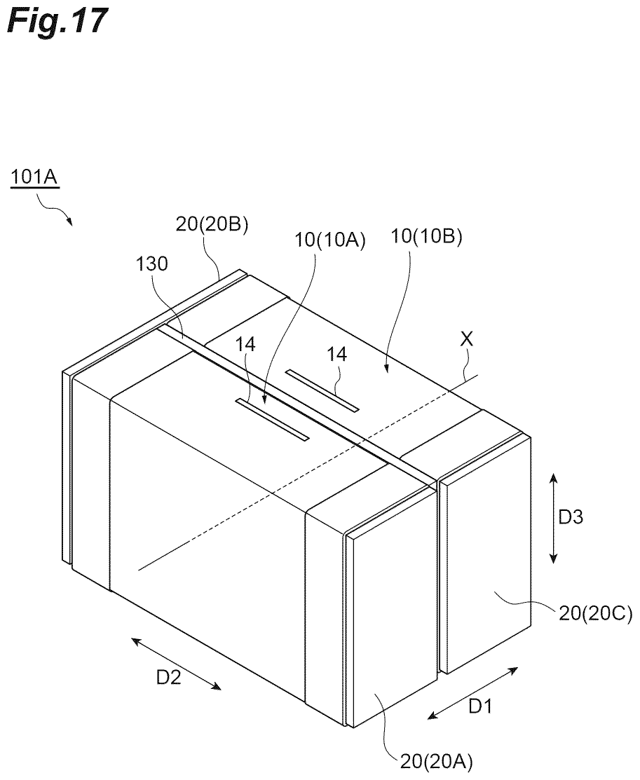

Further, the coil array is not limited to a coil array in which a plurality of coil components is connected in parallel, and may be a coil array in which a plurality of coil components is connected in series. FIG. 17 shows a coil array 101A in which the two coil components 10 are connected in series. The coil array 101A is of the three terminal type and comprises the three metal plates 20. Of the three metal plates 20, a first metal plate 20A covers only the external terminal 12A covering the end surface 11c of the first coil component 10A, a second metal plate 20B integrally covers the external terminals 12B covering the end surfaces 11d of the first coil component 10A and the second coil component 10B, and a third metal plate 20C covers only the external terminal 12A covering the end surface 11c of the first coil component 10B. In the coil array 101A, a voltage may be applied between the first metal plate 20A and the third metal plate 20C.

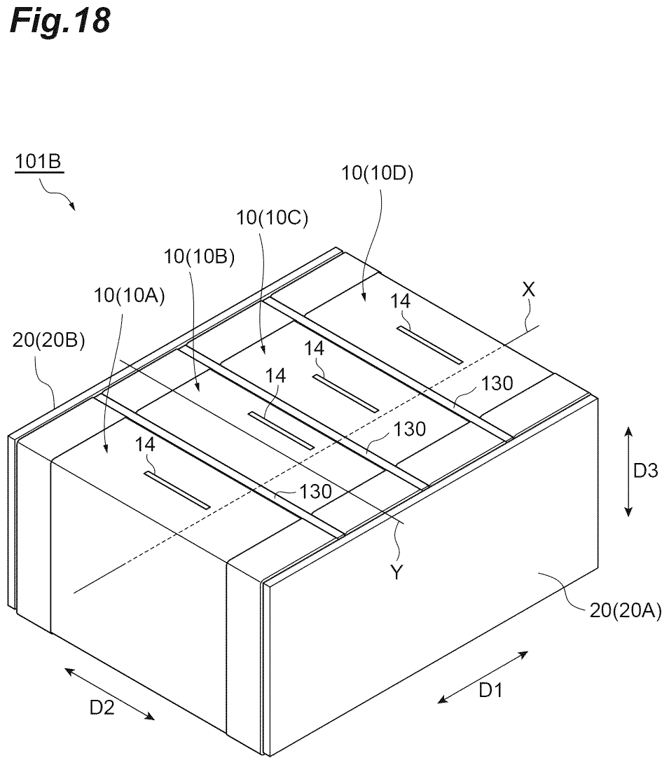

The number of the coil components 10 in the coil array 101 is not limited to two, and can be increased appropriately. FIG. 18 shows a coil array 101B including four coil components 10A to 10D. Depending on the number of the coil components 10, the dimensions of the metal plate 20 can be appropriately elongated. The adhesive layer 130 can be interposed between each of the adjacent coil components 10 in the first direction D1. In the coil array 101B, about four times the current can flow and the DC resistance can be reduced to about ¼ as compared with the case where the coil component 10 is used alone. In the coil array 101B, the insulating substrate 14 of a part of the four coil components 10A to 10D is offset. Specifically, the insulating substrate 14 of the coil 13 only in the coil component 10B is offset. In the coil array 101B, the direction of the magnetic flux generated in the coil 13 of each of the coil components 10A to 10D may be the same when voltage was applied between a pair of the metal plates 20. Or, the direction of the magnetic flux generated in the coil 13 of a part of the coil components 10 (for example, the coil component 10D) may be opposite to the others when voltage was applied between a pair of the metal plates 20. In this case, interference of coil magnetic flux may occur between the coil component 10C and the coil component 10D adjacent to each other.

In the second embodiment, the coil is not limited to an elliptical annular coil, and may be an annular coil, a rectangular annular coil, or the like. Further, the number of turns of the coil may be increased or decreased as appropriate.

What is claimed is:

1. A coil array comprising a plurality of coil components including an element body having a mounting surface facing a mounting substrate, a coil provided in the element body and having a coil axis along a first direction extending in parallel to the mounting surface, and a pair of external terminals provided on a surface of the element body and electrically connected to the coil,
wherein the plurality of the coil components is arranged along the first direction with the coil axis being common, and is connected in parallel.

2. The coil array according to claim 1, wherein the directions of the magnetic fluxes of the coils in all the plurality of the coil components are the same.

3. The coil array according to claim 1, wherein directions of the magnetic fluxes of the coils in the coil components adjacent to each other in the first direction are reverse.

4. The coil array according to claim 1, wherein the element body has a pair of side surfaces facing in the first direction, and at least a part of the side surface is curved.

5. The coil array according to claim 1, wherein the coil component further includes a substrate extending in a direction orthogonal to the mounting surface, and
wherein the mounting surface has a convex portion and a concave portion, a portion of the substrate is exposed from the mounting surface at the convex portion.

6. The coil array according to claim 1, further comprising a magnetic sheet interposed between the coil components adjacent to each other in the first direction.

7. The coil array according to claim 1, further comprising a metal plate integrally covering the external terminals of the plurality of the coil components.

8. The coil array according to claim 7, wherein an end portion of the metal plate on the mounting surface of the element body side is regressed from an edge of the external terminal.

9. A coil array comprising a plurality of coil components including an element body having metal magnetic powder, a coil having a substrate provided in the element body and orthogonal to a first direction and a planar coil pattern formed on a main surface of the substrate, and a pair of external terminals provided on a surface of the element body and electrically connected to the coil,
wherein the plurality of the coil components is arranged along the first direction, and at least one of the substrates in a pair of the coil components adjacent to each other in the first direction is biased to the substrate side of the other.

10. The coil array according to claim 9, wherein the plurality of the coil components is connected in parallel.

11. The coil array according to claim 9, wherein both of the substrates in the pair of the coil components adjacent to each other in the first direction are biased to approach each other.

12. The coil array according to claim 11, wherein both of the substrates in the pair of the coil components adjacent to each other in the first direction are biased by the same distance.

13. The coil array according to claim 9, wherein the plurality of the coil components is series-connected.

14. The coil array according to claim 9, wherein the element body of each of the coil components has a mounting surface facing a mounting substrate, and the first direction extends parallel to the mounting surface.

15. The coil array according to claim 9, further comprising an adhesive layer interposed between the coil components adjacent to each other in the first direction.

16. The coil array according to claim 15, wherein a distance between the planar coil patterns of the pair of the coil components adjacent to each other in the first direction is not more than 160 μm.
